(19) United States
(12) Patent Application Publication
(10) Pub. No.: US 2017/0240291 A1
(43) Pub. Date: Aug. 24, 2017

(54) FUEL CELL POWER PACK FOR MULTICOPTER

(71) Applicant: Hylium Industries, Inc., Seoul (KR)

(72) Inventor: Seo Young KIM, Seoul (KR)

(21) Appl. No.: 15/371,373

(22) Filed: Dec. 7, 2016

(30) Foreign Application Priority Data
Feb. 22, 2016 (KR) 10-2016-0020784

(51) Int. Cl. B64D 37/00; H02J 7/00; B64D 37/02; B64C 39/02; H01M 16/00; H01M 8/04082

(52) U.S. Cl. CPC B64D 37/005; H01M 16/006; H01M 8/04201; B64D 37/02; B64C 39/024; H02J 7/0052; H01M 2220/20; H01M 2250/20; B64C 2201/027; B64C 2201/042; B64C 2201/066; B64C 2201/108; B64C 2201/165

(57) ABSTRACT

A fuel cell power pack used as a power source in a multicopter includes a fuel tank and a fuel cell stack for producing electrical energy using hydrogen supplied from the fuel tank and supplying the electrical energy to a battery, and since the fuel cell stack is disposed at a certain point of an arm extended from the aircraft body in the radius direction (a point affected by a descending air current generated by each rotating blade), the electrical energy can be produced using the descending air current generated by the rotating blade without configuring a separate blowing apparatus.

### CROSS REFERENCE TO RELATED APPLICATION

The present application claims the benefit of Korean Patent Application No. 10-2016-0020784 filed in the Korean Intellectual Property Office on Feb. 22, 2016, the entire contents of which are incorporated herein by reference.

### BACKGROUND OF THE INVENTION

1. Field of the Invention

The present invention relates to a fuel cell power pack mounted on a multicopter, and more specifically, to a fuel cell power pack for a multicopter, which is used as a power source of the multicopter having a plurality of rotating blades symmetrically disposed in the horizon direction around an aircraft body as an unmanned aircraft controlled by radio waves or automatically operated by GPS positioning.

2. Description of Related Art

As the object and usage of a multicopter (so-called as a ‘drone’) generally manufactured to carry out military missions such as reconnaissance, surveillance, pinpoint strike and the like are diversified recently for the purpose of disaster monitoring, article transfer, image capturing, disaster relief and the like, its demand and utilization abruptly increase also in the civilian section.

Particularly, interest in the multicopter increases abruptly as to be the biggest issue in a variety of new technology fairs and exhibitions in recent years, and since its application field is indefinite, aviation advanced countries and IT companies around the world competitively invest in developing the techniques and strive for research and development of the techniques.

The multicopter is advantageous in that it can observe an area which is difficult to access for a person, such as a mountain area, and in particular, precise observation can be performed by low-level flight. In addition, the multicopter also attracts attention for military purposes from the point that it can easily infiltrate while evading radar networks by low-level flight.

The endurance time and flight distance of a multicopter may be determined according to the scope of utilization and purpose of use, and the endurance time and flight distance are changed according to a power source. In a conventional multicopter, it is general that a rechargeable secondary battery is mainly used as a power source, and an internal combustion engine is also used in some cases.

However, if the secondary battery is used as a power source, a lot of time is consumed to recharge the battery, and although it is fully charged, there is a limit in the flight distance or its usage since the multicopter may fly only for several to ten minutes or so, and although the internal combustion engine is advantageous from the aspect of securing the endurance time or flight distance, there is a problem in that it is difficult to meet the requirement of lightweightness and its noise is too loud.

Accordingly, an alternative of using a fuel cell generating low noise while securing a sufficient flight distance or endurance time as a power source is discussed recently. This is generating electrical energy needed for flight by reacting hydrogen H₂, which is a fuel, with oxygen O₂ in the air and supplying the energy to a rotor rotating motor for generating a thrust.

The fuel cell considered as an alternative power source of a multicopter includes a fuel tank for storing hydrogen fuel of a gaseous or liquid state and a fuel cell stack for producing electrical energy by reacting hydrogen supplied from the fuel tank with oxygen in the air.

FIG. 1 is a schematic side view showing a conventional multicopter mounted with a fuel cell spotlighted as an alternative power source, and FIGS. 2A and 2B are perspective views showing a fuel cell stack 3 attached to the aircraft body 1 of FIG. 1 from different angles.

As shown in FIG. 1, a fuel cell is frequently mounted on the aircraft body 1 which is the main body of the multicopter. At this point, the fuel cell is, as described above, configured of a fuel tank 2 for storing hydrogen, which is a fuel, and a fuel cell stack 3 actually producing electricity for starting up the fuselage using the hydrogen supplied from the fuel tank 2.

The multicopter is configured by disposing the fuel tank 2 and the fuel cell stack 3 up and down at the center of the aircraft body 1 to be spaced apart from each other as shown in FIG. 1 in consideration of weight balance of the fuselage, or although it is not shown in the figure, the multicopter is configured in a structure of constructing a fuel tank and a fuel cell stack in the form of one module and attaching and detaching them to and from the aircraft body to secure a space and miniaturize the aircraft body.

As shown in FIGS. 2A and 2B, the fuel cell stack 3 is configured in a structure of forming an air gap to flow air into unit cells 32 through an opening formed on the top surface by disposing several unit cells 32 to be stacked in a housing 30 with an top surface and a partially open opposing bottom surface.

The hydrogen, which is a fuel, is supplied into the housing 30 through a hydrogen supply port 31 formed on the side surface of the housing, and a blowing apparatus 35 such as a fan or a blower for cooling down the apparatus and forcibly flowing the outside air, which will react with the hydrogen, into the housing through the air gap is mounted on the partially open bottom surface of the housing 30.

Since the blowing apparatus is driven by electricity, electrical energy is consumed. Accordingly, when a fuel cell is used as a driving source, a parasitic loss will be a problem, and since the wind generated when the fan or the blower is driven acts as a drag force in some cases, it may be a factor of decreasing maneuverability of the multicopter.

In addition, there is a problem in that since the weight of the multicopter increases as much as the weight of the blowing apparatus and thus electricity is consumed faster, the overall energy efficiency is lowered, and although a fuel cell is applied therefore, a flight distance and endurance time cannot be secured sufficiently.

### SUMMARY OF THE INVENTION

Therefore, the present invention has been made in view of the above problems, and it is an object of the present invention to provide a fuel cell power pack for a multicopter, which can exclude use of a blowing apparatus such as a fan or a blower.

According to a first embodiment of the present invention as a means for solving the problem, there is provided a fuel cell power pack used as a power source in a multicopter having a plurality of arms and rotating blades symmetric about an aircraft body in the horizontal direction, the fuel cell including: a fuel tank mounted on the aircraft body to store hydrogen fuel of a gaseous or liquid state; a battery mounted on the aircraft body together with the fuel tank to store electrical energy generated as the hydrogen fuel reacts with air and supply the electrical energy to a driving motor which drives the rotating blade; and a fuel cell stack for producing the electrical energy by reacting the hydrogen fuel supplied from the fuel tank with oxygen in the air flowing in from the outside and supplying the produced electrical energy to the battery, in which the fuel cell stack is mounted on an arm within an area affected by the thrust of the rotating blade.

In the first embodiment, the fuel cell stack may be a configuration having a plurality of unit cells embedded in a housing aerodynamically designed and having an air inlet and an air outlet respectively formed at an upper portion and a lower portion.

In addition, in the first embodiment, the housing of the fuel cell stack may be formed in the shape of a cone having a diameter or width gradually narrowed toward the rotating blade.

On the other hand, according to a second embodiment of the present invention as a means for solving the problem, there is provided a fuel cell power pack used as a power source in a multicopter having a plurality of arms and rotating blades symmetric about an aircraft body in the horizontal direction, the fuel cell including: a fuel tank mounted on the aircraft body to store hydrogen fuel of a gaseous or liquid state; a battery mounted on the aircraft body together with the fuel tank to store electrical energy generated as the hydrogen fuel reacts with air and supply the electrical energy to a driving motor which drives the rotating blade; and a fuel cell stack for producing the electrical energy by reacting the hydrogen fuel supplied from the fuel tank with oxygen in the air flowing in from the outside and supplying the produced electrical energy to the battery, in which the fuel cell stack is mounted on an arm outside a tip of the rotating blade to be close to the tip.

In the second embodiment, the fuel cell stack may be a configuration embedded with a plurality of unit cells disposed to be stacked inside an aerodynamically designed housing with an open one side facing the tip and an open opposite side.

In addition, in the second embodiment, a guide vane for guiding a lateral side wing tip vortex of the rotating blade to flow into the fuel cell stack may be installed at one side of the housing of the fuel cell stack facing the tip.

At this point, the guide vale may be configured in the shape of a smoothly curved tube on a curved line toward the tip.

Here, the fuel cell stack applied to the first embodiment and the second embodiment may be attached to all arms extended in a radius direction of the aircraft body.

Alternatively, the fuel cell stack may be attached to only some of the arms symmetrical about the aircraft body.

In addition, according to a third embodiment of the present invention as a means for solving the problem, there is provided a fuel cell power pack used as a power source in a multicopter having a plurality of arms and rotating blades symmetric about an aircraft body in the horizontal direction, the fuel cell including: a fuel tank mounted on the aircraft body to store hydrogen fuel of a gaseous or liquid state; a battery mounted on the aircraft body together with the fuel tank to store electrical energy generated as the hydrogen fuel reacts with air and supply the electrical energy to a driving motor which drives the rotating blade; and a fuel cell stack for producing the electrical energy by reacting the hydrogen fuel supplied from the fuel tank with oxygen in the air flowing in from the outside and supplying the produced electrical energy to the battery, in which a motor housing with an open top and an open bottom is provided at the front end of an arm, the driving motor is mounted in the motor housing, and the fuel cell stack is mounted under the driving motor inside the motor housing.

In the third embodiment, the driving motor and the fuel cell stack may be vertically lined up to align their center lines, and the fuel cell stack may be formed to have a width at least larger than the width of the driving motor.

In addition, in the third embodiment, the motor housing may be formed in an aerodynamically designed spindle shape having a swollen center portion not to affect the thrust of the multicopter.

Here, in the third embodiment, one fuel cell stack may be mounted inside the motor housing provided at the front end of all arms.

Alternatively, one fuel cell stack may be installed only inside the motor housing provided at the front end of some of the arms symmetrical about the aircraft body.

### BRIEF DESCRIPTION OF THE DRAWINGS

FIG. 1 is a schematic side view showing a conventional multicopter mounted with a fuel cell.

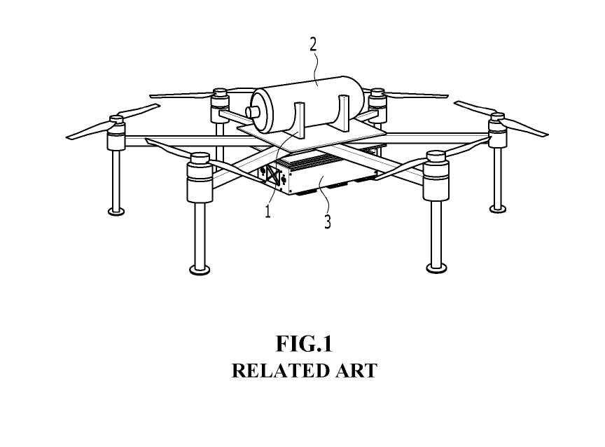

FIGS. 2A and 2B are perspective views showing a fuel cell stack attached to the aircraft body of FIG. 1 from different angles.

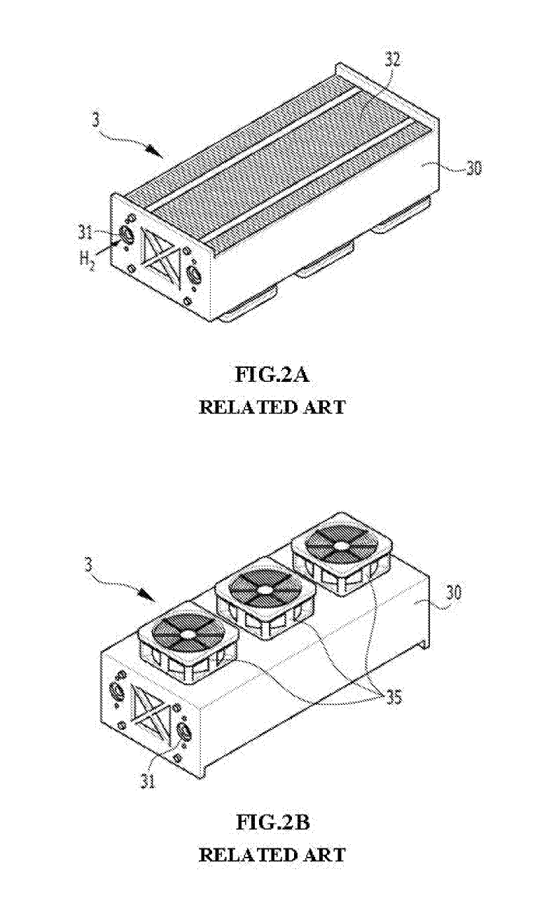

FIG. 3 is a conceptual planar view showing a multicopter to which a fuel cell power pack according to a first embodiment of the present invention is applied.

FIG. 4 is a conceptual side view showing a multicopter to which a fuel cell power pack according to a first embodiment of the present invention is applied.

FIG. 5 is an enlarged side view showing the front end of an arm on which a fuel cell stack of a fuel cell power pack according to a first embodiment of the present invention is mounted.

FIG. 6 is a plan view showing the front end of an arm of FIG. 5 from the top.

FIG. 7 is a cross-sectional view showing the front end of an arm of FIG. 6 taken along the cutting line A-A.

FIG. 8 is an enlarged side view showing the front end of an arm on which a fuel cell stack of a fuel cell power pack according to a second embodiment of the present invention is mounted.

FIG. 9 is an enlarged side view showing the front end of an arm on which a fuel cell stack of a fuel cell power pack according to a third embodiment of the present invention is mounted.

FIGS. 10A and 10B are views showing an embodiment related to disposition of a fuel cell stack of a fuel cell power pack according to an embodiment of the present invention.

### DETAILED DESCRIPTION OF THE PREFERRED EMBODIMENT

Hereafter, the preferred embodiments of the invention will be described in detail.

The terms used in the specification are used to describe only specific embodiments and are not intended to limit the present invention. Singular forms are intended to include plural forms unless the context clearly indicates otherwise. It will be further understood that the terms “include”, “comprise” or “have” used in this specification specify the presence of stated features, numerals, steps, operations, components, parts, or a combination thereof, but do not preclude the presence or addition of one or more other features, numerals, steps, operations, components, parts, or a combination thereof.

The terms such as “first”, “second” and the like can be used in describing various elements, but the above elements shall not be restricted to the above terms. The above terms are used only to distinguish one element from the other.

In addition, the terms such as “unit”, “module” and the like disclosed in the specification indicate a unit for performing at least one function or operation and may be implemented by hardware, software or a combination hardware and software.

In describing with reference to the accompanying drawings, any identical or corresponding elements will be given same reference numerals, and description of the identical or corresponding elements will not be repeated. In describing the present invention, when it is determined that the detailed description of the known art related to the present invention may obscure the gist of the present invention, the detailed description thereof will be omitted.

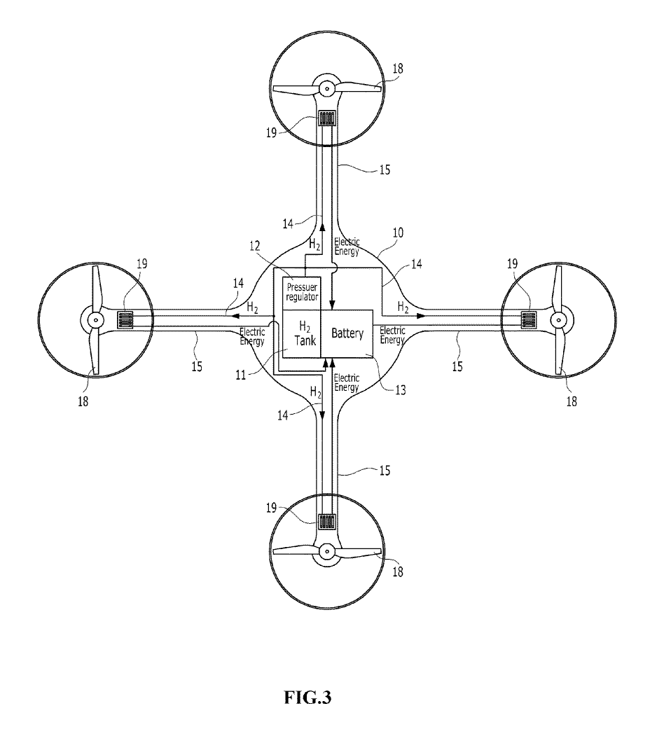

Hereinafter, as a preferred example of a multicopter, an example of a quadcopter will be described, in which four rotating blades are disposed around an aircraft body so that blades facing each other are symmetrical as shown in FIG. 3. It is noted that the present invention described below is not limited to the multicopter having four rotating blades as shown in FIG. 3.

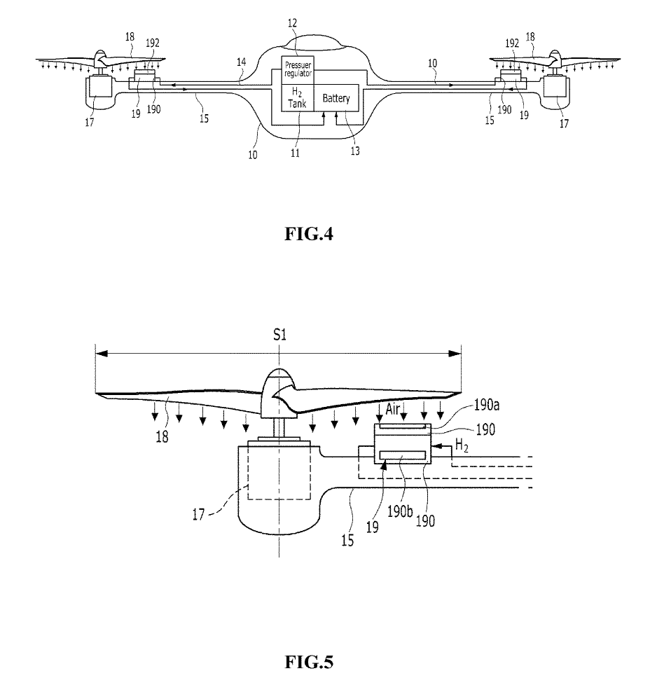

FIG. 3 is a conceptual planar view showing a multicopter to which a fuel cell power pack according to a first embodiment of the present invention is applied, and FIG. 4 is a conceptual side view showing a multicopter to which a fuel cell power pack according to a first embodiment of the present invention is applied. A schematic configuration of a multicopter mounted with a fuel cell power pack according to the present invention and the concept of the present invention will be described with reference to the figures.

Referring to FIGS. 3 and 4, a multicopter to which a fuel cell power pack according to the present invention is applied is a fuel cell multicopter using a fuel cell as a power source, in which a fuel cell stack 19 is disposed in the close neighborhood of each rotating blade 18 or some of rotating blades 18 to produce electricity by efficiently using air current generated by the rotational blades 18.

Specifically, the fuel cell stack 19 producing electrical energy using hydrogen supplied from a fuel tank 11 and supplying the electrical energy to a battery 13 is disposed on an arm 15 extended from the aircraft body in the radius direction, and thus the fuel cell stack 19 operates by the air current (a descending air current or a wing tip vortex) generated by the rotating blades 18 without a separate blowing apparatus.

The present invention will be described in more detail.

A multicopter to which a fuel cell power pack according to the present invention is applied includes an aircraft body 10. A wireless signal transceiver, a controller for general flight control including a posture of a fuselage and the like may be mounted on the aircraft body 10. Four rotating blades 18 with a central rotating axis approximately vertical to the ground are disposed around the aircraft body 10 so that blades facing each other are symmetrical about the aircraft body 10.

Four arms 15 are extended from the aircraft body 10 in the radius direction. A driving motor 17 for receiving the electrical energy from the battery 13 mounted on the aircraft body 10 together with the fuel tank 11 and driving the rotating blade 18 to rotate is mounted at the front end of each arm 15. Adjacent driving motors 17 generate rotating forces of different directions, and driving motors 17 in the diagonal directions generate rotating forces of the same direction.

Fuel, which is an energy source, is stored in the fuel tank 11. The fuel tank 11 is mounted on the aircraft body 10. The fuel contained in the fuel tank 11 may be hydrogen fuel of a gaseous or liquid state. The hydrogen fuel is supplied to the fuel cell stack 19 disposed at a certain point of the arm 15 through a fuel supply tube 14 installed inside or outside the arm 15 along the arm 15 in a gaseous state.

The hydrogen stored in the fuel tank 11 may be filled in the form of high-pressure gas or liquid hydrogen. If the liquid hydrogen is used as a fuel, the volume of the fuel can be reduced greatly, and thus restriction in design can be reduced from the aspect of weight balance of the aircraft body 10 and the aspect of mechanical design of the fuel tank 11.

A pressure regulator 12 may be installed at the fuel outlet of the fuel tank 11. The hydrogen of a liquid or gaseous state injected into the fuel tank 11 may be evaporated due to increase of internal temperature according to heat exchange with the outside (in the case of gaseous hydrogen, it becomes a high-pressure gaseous state as the internal temperature increases), adjusted to a predetermined pressure while passing through the pressure regulator 12, and supplied to the fuel cell stack 19 as a fuel.

Apparently, other than the method of directly using pure hydrogen of a liquid or gaseous state as a fuel, all types of publicized hydrogen supply methods, such as an Active Type Direct Methanol Fuel Cell (DMFC) method, a Passive Type Direct Methanol Fuel Cell (DMFC) method or the like which uses a compound containing hydrogen molecules (natural gas or methanol of high energy density) as a fuel or extracts and supplies hydrogen from a compound through reformation, may be adopted.

Although it is not shown in the figure, a hydrogen preheater for preheating the hydrogen fuel supplied in a gaseous state may be disposed in the fuel supply tube 14 which forms a hydrogen supply passage. In addition, together with the fuel tank 11, the battery 13 for storing the electrical energy produced by the fuel cell stack 19 and supplying the stored electrical energy to the driving motor 17 which drives the rotating blade 18 is mounted on the aircraft body 10. If the duel tank 11 and the battery 13 are configured as a single structure in the form of a module, this is advantageous from the aspect of securing a space for mounting them on the aircraft body 10 and miniaturizing the fuselage.

In addition, the fuel cell stack 19 in charge of receiving the hydrogen fuel from the fuel tank 11 and practically generating the electrical energy is attached to the arm 15 in the neighborhood of the rotating blade 18.

The fuel cell stack 19 produces electrical energy by reacting the hydrogen fuel supplied from the fuel tank 11 with oxygen in the air flowing in from the outside. Then, the fuel cell stack 19 supplies the electrical energy to the battery 13. The battery 13 stores the electrical energy supplied from the fuel cell stack 19 and supplies the electrical energy to each driving motor 17 as much as needed.

Specifically, the fuel cell stack 19 includes a housing 190 and a plurality of unit cells 192 embedded in the housing 19 in the form a stack. Each of the unit cells 192 is configured of a membrane electrode assembly (MEA), a diffusion plate, a separator plate and the like, and electrical energy and water are produces by oxidation of hydrogen at the anode where oxygen is supplied and reduction of oxygen at the cathode where the air is supplied.

The fuel cell stack 19 may be disposed at a certain point of the arm 15. Here, the certain point includes all points existing in an area affected by air current generated by the rotating blade 18. At this point, the air current generated by the rotating blade 18 may be a descending air current generating a lift and a thrust or a wing tip vortex generated at the tip of the rotating blade 18.

That is, since the fuel cell stack 19 which produces electricity is disposed in the close neighborhood of each rotating blade 18 or some of rotating blades 18, the fuel cell power pack of the present invention produces electricity and cools down the heat generated by chemical reaction by flowing in the outside air using only the air current generated by the rotating blade 18 while excluding use of a fan or a blower which consumes the electrical energy.

Hereinafter, each of the preferred embodiments of the present invention will be described in more detail.

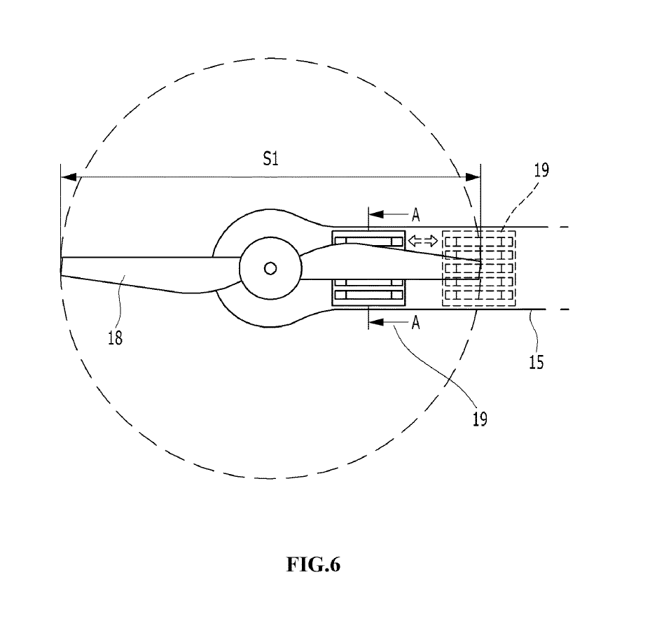

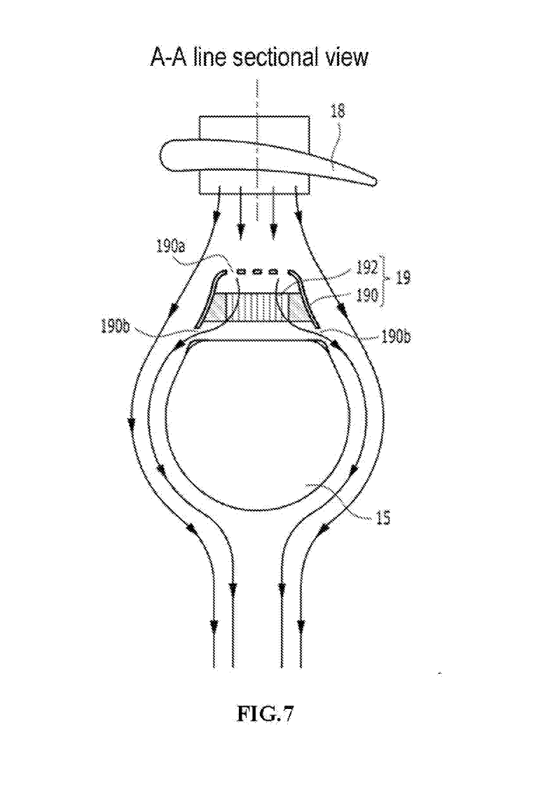

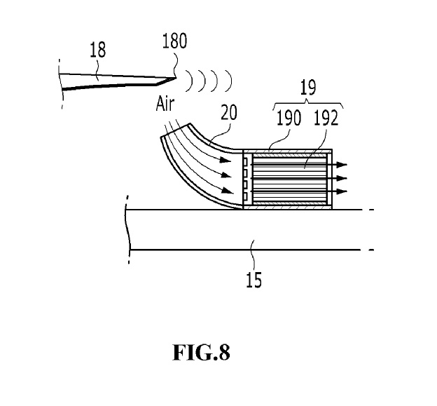

FIG. 5 is an enlarged side view showing the front end of an arm on which a fuel cell stack of a fuel cell power pack according to a first embodiment of the present invention is mounted, FIG. 6 is a plan view showing the front end of an arm of FIG. 5 from the top, and FIG. 7 is a cross-sectional view showing the front end of an arm of FIG. 6 taken along the cutting line A-A.

Referring to FIGS. 5 to 7, one or more fuel cell stacks 19 applied to a first embodiment are installed on the arm in an area S1 affected by the thrust of the rotating blade 18. Here, the area affected by the thrust does not mean only the inside of a geometric circular trajectory drawn by the wing tip of the rotating blade 18 as shown in FIG. 6 for example, but means an area including all the areas aerodynamically affected by the thrust, beyond the boundary of the trajectory.

The fuel cell stack 19 according to a first embodiment may be a configuration of disposing several unit cells 192 to be stacked inside the housing 190. At this point, as shown in FIG. 7 for example, the housing 190 may be formed in an aerodynamic shape having an air inlet 190a and an air outlet 190b respectively formed at an upper portion and a lower portion, preferable in the shape of a cone having a diameter or width narrowed toward the rotating blade 18.

If the housing 190 is formed in the shape of a cone as shown in FIG. 7, loss of thrust of the rotating blade 18 by the fuel cell stack 19 can be minimized, and thus the effect of the fuel cell stack 19 on the performance of the multicopter can be reduced greatly.

Apparently, although it is not specifically illustrated through the drawings, it may be configured to expose only part of the top of the housing, through which the air flows in, toward the top surface of the arm 15 and bury the other part inside the arm 15. In this case, since the area of the fuel cell stack 19 directly contacting with the air current is reduced, loss of thrust by the fuel cell stack 19 can be reduced furthermore.

In addition, a modification of disposing the fuel cell stack 19 on the bottom of the arm 15 within an area affected by the thrust generated by the rotating blade 18 may be considered (not shown). This is an embodiment of driving the fuel cell stack 19 using a swirl flow generated on the bottom of the arm 15 by a laminar flow type air current moving along both side surfaces of the arm 15, out of the descending air current generating the thrust.

Alternatively, it may be configured to tilt the fuel cell stack 19 along the circumferential direction of the arm 15 within a predetermined range using a tilting member (not shown) of an approximate ring shape combined with the outer surface of the arm 15. That is, it may be configured to change the posture of disposition of the fuel cell stack 19 at an angle capable of implementing optimal flow of the air in accordance to the direction of flow of the descending air current.

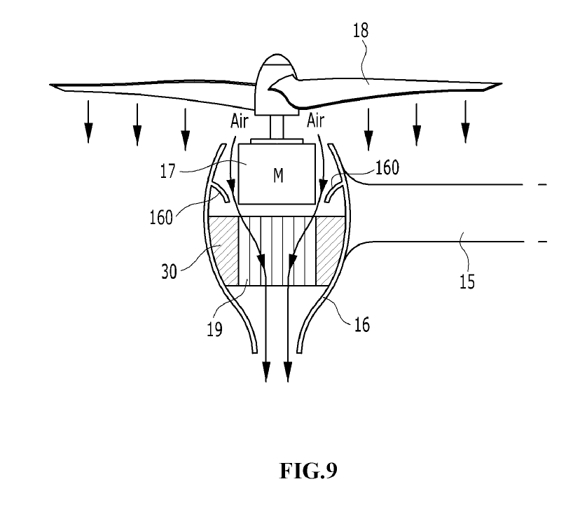

FIG. 8 is an enlarged side view showing the front end of an arm on which a fuel cell stack of a fuel cell power pack according to a second embodiment of the present invention is mounted.

Referring to FIG. 8, one or more fuel cell stacks 19 may be installed on the arm 15 to be close to the outer portion of the tip 180 of the rotating blade 18. Here, it is most preferable to understand the expression of ‘on the arm 15’ as the top surface of the arm 15 facing the rotating blade 18. However, it is not limited to the top surface, but may even include both side surfaces of the arm 15.

The fuel cell stack 19 of the second embodiment is driven by a wing tip vortex, which is a wing tip swirl generated on the side surface of the blade when the rotating blade 18 rotates. That is, since the fuel cell stack 19 is driven by a lateral side mobile air current generated by the wing tip swirl generated by the rotating blade 18, electrical energy is produced, and cooling down of the fuel cell stack is implemented.

The fuel cell stack 19 applied to the second embodiment may be configured by stacking a plurality of unit cells 192 configured of a membrane electrode assembly (MEA), a diffusion plate and a current collecting plate in the vertical direction (up and down) inside the housing 190 of an aerodynamic shape, which is open to allow flow of the air along one side facing the tip 180 and the opposite side.

Furthermore, a guide vale 20 may be installed at the air inlet side of the fuel cell stack 19. The guide vale 20 is a means for guiding smooth inflow of a blade lateral side mobile air current (the wing tip vortex) into the fuel cell stack 19, which can be formed in the shape of a smoothly curved tube on a curved line toward the tip 180 as shown in the figure for example.

Apparently, the guide vale is not limited to the curved tube shape shown in the figure for example. If the guide vale is in a shape or a structure allowing smooth inflow of the lateral side mobile air current, it may be applied regardless of a specific shape or structure. In addition, also the direction or position of the inlet is not limited to a specific direction or position. For example, the inlet may be formed to slantingly face the circular direction along which the rotating blade 18 rotates.

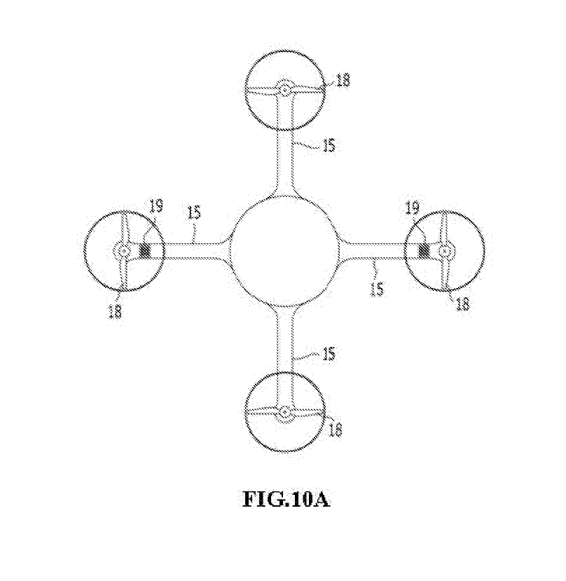

FIG. 9 is an enlarged side view showing the front end of an arm on which a fuel cell stack of a fuel cell power pack according to a third embodiment of the present invention is mounted.

The third embodiment of FIG. 3 is characterized in that the fuel cell stack 19 is disposed under the driving motor 17 positioned at the front end of the arm 15. Specifically, the fuel cell stack 19 is disposed under the driving motor 17 inside the motor housing 16 positioned at the front end of the arm 15, and the fuel cell stack 19 operates by the descending air current passing through the motor housing 16, out of the entire descending air current generated by the rotating blade 18.

The motor housing 16 applied to the third embodiment may be a cylindrical structure with an open top and an open bottom. Preferably, the motor housing 16 may be a hollow tube shape having an open top and an open bottom, which is aerodynamically designed not to affect the thrust of the multicopter and shaped in a spindle having a swollen center portion while being narrowed toward the both ends of the top and the bottom.

The driving motor 17 may be stably fixed at a predetermined position inside the motor housing 16 using a supporting frame formed with a through hole or a strut (not shown) of a bar shape. In addition, the fuel cell stack 19 may be stably attached right under the driving motor 17 passing through a circular structure 30 tightly coupled to the inner periphery of the motor housing 16.

A guide vane 160 for guiding the air to be smoothly supplied to the fuel cell stack 19 may be installed on the inner periphery of the motor housing 16, and from the aspect of weight balance, it is advantageous to dispose the driving motor 17 and the fuel cell stack 19 to align the center lines thereof with each other. In addition, the width of the fuel cell stack 19 is designed to be larger than that of the driving motor 17 so that air may be supplied to the fuel cell stack 19 as much as possible.

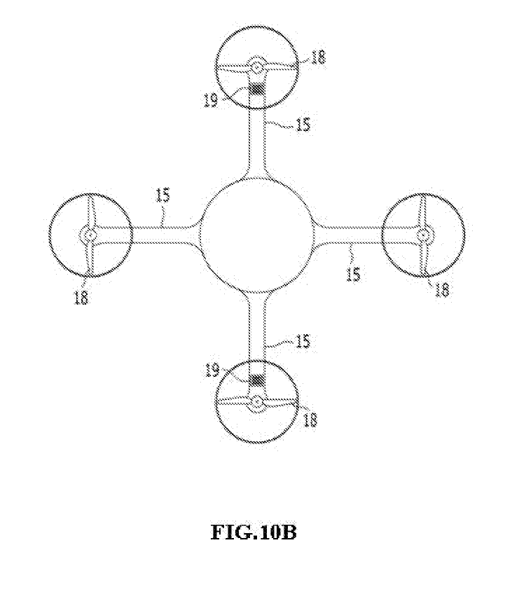

Meanwhile, FIGS. 10A and 10B are views showing an embodiment related to disposition of a fuel cell stack of a fuel cell power pack according to an embodiment of the present invention.

The fuel cell stack 19 applied to the first to third embodiments of the fuel cell power pack according to the present invention may be installed at a certain point of the arm 15 as shown in FIG. 3 or may be installed in some of the arms 15 symmetric about the aircraft body 10 as shown in FIGS. 10A and 10B, i.e., only in some of the arms 15 diagonally facing each other and forming a pair.

For example, if there are four arms 15 as shown in the example of FIGS. 10A and 10B, the fuel cell stack 19 may be installed only in a pair of arms 15 facing each other. Apparently, if an even number of arms 15 more than four are formed, the fuel cell stack 19 may be installed, among all the arms 15, in a pair of arms 15 forming a pair in a diagonal direction, in all the arms 15 other than the pair of arms 15 forming a pair in a diagonal direction, or in all the arms 15 other than some pairs.

In other words, if the fuel cell stack 19 is installed only in some of the arms 15, a plurality of fuel cell stacks 19 only needs to be symmetric with each other about the aircraft body 10 considering overall weight balance. Apparently, it should be understood that the symmetricity herein means that the distance of the fuel cell stacks 19 from the aircraft body 10 is the same and, in addition, the size and the weight of the fuel cell stacks 19 should be the same.

According to the fuel cell power pack for a multicopter according to an embodiment of the present invention, although the rotating blades are driven by electricity of the battery in the initial stage of start-up, once the rotating blades are driven, the fuel cell stack operates and produces power by the air current (a descending air current or a wing tip vortex) generated by the rotating blades, and the produced power is charged in the battery, and thus electricity may be supplied for a further extended period of time.

Particularly, since the fuel cell stack which produces electrical energy is disposed in the neighborhood of the rotating blade performing a rotation motion, the fuel cell power pack for a multicopter according to an embodiment of the present invention does not need any more a blowing apparatus, such as a fan or a blower for flowing outside air into the fuel cell stack or cooling down the apparatus.

That is, the present invention is advantageous in lightweightness of a multicopter as the use of a blowing apparatus is excluded and has an effect of increasing energy efficiency and endurance time since a parasitic loss consumed by the blowing apparatus can be removed, and in addition, since costs of parts can be saved from the aspect of cost, a multicopter having price competitiveness can be implemented.

According to the fuel cell power pack for a multicopter according to an embodiment of the present invention, the rotating blades are driven by electricity of the battery in the initial stage of starting up, and the fuel cell stack operates and produces power by the air current (a descending air current or a wing tip vortex) generated as the rotating blades are driven, and then the produced power is charged in the battery, and thus electricity can be supplied for a further extended period of time.

Particularly, since the fuel cell stack which produces electrical energy is disposed in the neighborhood of the rotating blade performing a rotation motion, the fuel cell power pack for a multicopter according to an embodiment of the present invention does not need any more a blowing apparatus, such as a fan or a blower for flowing outside air into the fuel cell stack or cooling down the apparatus.

That is, the present invention is advantageous in lightweightness of a multicopter as the use of a blowing apparatus is excluded and has an effect of increasing energy efficiency and endurance time since a parasitic loss consumed by the blowing apparatus can be removed, and in addition, since costs of parts can be saved from the aspect of cost, a multicopter having price competitiveness can be implemented.

In the above detailed description of the present invention, only particular embodiments according thereto have been described. However, it should be understood that the present invention is not limited to the particular forms mentioned in the detailed description and rather includes all modifications, equivalents and alternatives falling within the spirit and scope of the present invention as defined by the claims.

What is claimed is:

1. A fuel cell power pack used as a power source in a multicopter having a plurality of arms and rotating blades symmetric about an aircraft body in a horizontal direction, the fuel cell comprising:
a fuel tank mounted on the aircraft body to store hydrogen fuel of a gaseous or liquid state;
a battery mounted on the aircraft body together with the fuel tank to store electrical energy generated as the hydrogen fuel reacts with air and supply the electrical energy to a driving motor which drives the rotating blade; and
a fuel cell stack for producing the electrical energy by reacting the hydrogen fuel supplied from the fuel tank with oxygen in air flowing in from outside and supplying the produced electrical energy to the battery,
wherein the fuel cell stack is mounted on an arm within an area affected by a thrust of the rotating blade.

2. The fuel cell according to claim 1, wherein the fuel cell stack has a plurality of unit cells embedded in a housing aerodynamically designed and having an air inlet and an air outlet respectively formed at an upper portion and a lower portion.

3. The fuel cell according to claim 2, wherein the housing of the fuel cell stack is formed in a shape of a cone having a diameter or width gradually narrowed toward the rotating blade.

4. A fuel cell power pack used as a power source in a multicopter having a plurality of arms and rotating blades symmetric about an aircraft body in a horizontal direction, the fuel cell comprising:
a fuel tank mounted on the aircraft body to store hydrogen fuel of a gaseous or liquid state;
a battery mounted on the aircraft body together with the fuel tank to store electrical energy generated as the hydrogen fuel reacts with air and supply the electrical energy to a driving motor which drives the rotating blade; and
a fuel cell stack for producing the electrical energy by reacting the hydrogen fuel supplied from the fuel tank with oxygen in air flowing in from outside and supplying the produced electrical energy to the battery,
wherein the fuel cell stack is mounted on an arm outside a tip of the rotating blade to be close to the tip.

5. The fuel cell according to claim 4, wherein the fuel cell stack is a configuration embedded with a plurality of unit cells disposed to be stacked inside an aerodynamically designed housing with an open one side facing the tip and an open opposite side.

6. The fuel cell according to claim 5, wherein a guide vane for guiding a lateral side wing tip vortex of the rotating blade to flow into the fuel cell stack is installed at one side of the housing of the fuel cell stack facing the tip.

7. The fuel cell according to claim 6, wherein the guide vale is configured in a shape of a smoothly curved tube on a curved line toward the tip.

8. The fuel cell according to claim 1, wherein the fuel cell stack is attached to all arms extended in a radius direction of the aircraft body.

9. The fuel cell according to claim 1, wherein the fuel cell stack is attached to only some of the arms symmetrical about the aircraft body.

10. The fuel cell according to claim 4, wherein the fuel cell stack is attached to all arms extended in a radius direction of the aircraft body.

11. The fuel cell according to claim 4, wherein the fuel cell stack is attached to only some of the arms symmetrical about the aircraft body.

12. A fuel cell power pack used as a power source in a multicopter having a plurality of arms and rotating blades symmetric about an aircraft body in a horizontal direction, the fuel cell comprising:
a fuel tank mounted on the aircraft body to store hydrogen fuel of a gaseous or liquid state;
a battery mounted on the aircraft body together with the fuel tank to store electrical energy generated as the hydrogen fuel reacts with air and supply the electrical energy to a driving motor which drives the rotating blade; and
a fuel cell stack for producing the electrical energy by reacting the hydrogen fuel supplied from the fuel tank with oxygen in air flowing in from outside and supplying the produced electrical energy to the battery,
wherein a motor housing with an open top and an open bottom is provided at a front end of an arm, the driving motor is mounted in the motor housing, and the fuel cell stack is mounted under the driving motor inside the motor housing.

13. The fuel cell power pack according to claim 12, wherein the driving motor and the fuel cell stack are vertically lined up to align their center lines, and the fuel cell stack is formed to have a width at least larger than a width of the driving motor.

14. The fuel cell power pack according to claim 12, wherein the motor housing is an aerodynamically designed spindle shape having a swollen center portion not to affect a thrust of the multicopter.

15. The fuel cell power pack according to claim 12, wherein one fuel cell stack is mounted inside the motor housing provided at the front end of all arms.

16. The fuel cell power pack according to claim 13, wherein one fuel cell stack is mounted inside the motor housing provided at the front end of all arms.

17. The fuel cell power pack according to claim 14, wherein one fuel cell stack is mounted inside the motor housing provided at the front end of all arms.

18. The fuel cell power pack according to claim 12, wherein one fuel cell stack is installed only inside the motor housing provided at the front end of some of the arms symmetrical about the aircraft body.

19. The fuel cell power pack according to claim 13, wherein one fuel cell stack is installed only inside the motor housing provided at the front end of some of the arms symmetrical about the aircraft body.

20. The fuel cell power pack according to claim 14, wherein one fuel cell stack is installed only inside the motor housing provided at the front end of some of the arms symmetrical about the aircraft body.
